(19) United States
(12) Patent Application Publication
(10) Pub. No.: US 2010/0123436 A1
(43) Pub. Date: May 20, 2010

(54) OPTIMIZED LITHIUM-ION BATTERY CHARGING

(75) Inventors: Allan Herrod, Mission Viejo, CA (US); Steven Eric Woloschin, Smithtown, NY (US)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Holtsville, NY (US)

(21) Appl. No.: 12/270,922

(22) Filed: Nov. 14, 2008

(51) Int. Cl. H02J 7/00

(52) U.S. Cl. 320/132; 320/133

(57) ABSTRACT

A device optimized battery-charging system for extending the useful life of a rechargeable battery. The optimized battery-charging system predicts periods of use and non-use of the device containing the battery and generates a schedule of when to charge the battery so the battery is ready for the next use cycle. During non-use cycles, the optimized battery-charging system reduces the battery charge level to an optimum level for storage based on the battery chemistry. When charging or discharging the battery, the optimized battery-charging system calculates a rate of charge or discharge that assures that the battery temperature does not exceed a preconfigured maximum value.

### TECHNICAL FIELD

The subject invention relates generally to battery charging systems, and more particularly to Lithium-Ion battery charging systems and intelligence associated with optimizing the charge cycle and extending the useful life of a Lithium-Ion battery.

### BACKGROUND

Mobile devices have become ubiquitous in today's society and almost every person you meet carriers one for one purpose or another. These mobile devices include mobile computers, cordless telephones, cellular telephones, global positioning location systems, portable music players, two-way radios, inventory devices and the like. Each of these mobile devices requires power for operation and in most cases, a battery provides the power to the mobile device. As society has come to depend on these mobile devices to a greater degree, the pressure for batteries that last longer between charges, recharge faster, provide longer battery useful life, have no “memory effect” and are lighter has driven the market to battery technology such as the Lithium-Ion battery.

Lithium-Ion batteries are well adapted to meet these design demands with regard to charge capacity, weight reduction, recharge time, and “memory effect” but they have other problems associated with their technology. For example, the chemical nature of Lithium-Ion batteries is a poor match for both the typical usage patterns of the mobile device user and the current battery charger designs. In fact, one of the worst scenarios for a Lithium-Ion battery is storage in a fully charged state with little or no load.

The design of most current Lithium-Ion charging systems, while simple for use by the mobile device user and perhaps acceptable for previous battery technologies, is not the ideal charging systems for Lithium-Ion batteries. The design of current Lithium-Ion charging systems is to maintain the Lithium-Ion battery in a state of full charge when not in use. While this strategy is simple, convenient and perhaps in line with what a user expects, it is far from the best circumstances for the life of the Lithium-Ion battery. Under these circumstances, the Lithium-Ion battery chemistry degrades even though the battery is not delivering any operational benefit other than readiness for use.

Another Lithium-ion battery chemistry issue, too high a temperature during a charging or discharging cycle adversely affects the useful life of a Lithium-Ion battery. For example, current charging system design usually recharges a Lithium-Ion battery as quickly as possible to reduce the amount of time a user may have to wait to continue using the mobile device. Charging or discharging a Lithium-Ion battery too quickly will raise the temperature of the Lithium-Ion battery to a point where battery chemistry is degraded leading to a reduction in the useful life of the Lithium-Ion battery.

Accordingly, deficiencies in existing charge systems and market pressure for longer battery useful life has led to the need for a Lithium-Ion battery charging system capable of optimizing the charging characteristics to extend the life of a Lithium-Ion battery.

### SUMMARY

The following presents a simplified summary in order to provide a basic understanding of some of the aspects described herein. This summary neither is an extensive overview nor intended to identify key or critical elements or to delineate the scope of the various aspects described herein. The sole purpose of the summary is to present some concepts in a simplified form as a prelude to the more detailed description presented later.

The disclosure describes systems and methods for optimizing the charging system associated with the Lithium-Ion battery of a mobile device. The innovation uses a combination of historical use data and a prediction of future use patterns to develop a schedule of the point in time when a full charge is required. The innovation then reduces the charge level of the Lithium-Ion battery to a calculated point to optimize the useful life of the Lithium-Ion battery. At a later point in time calculated by the disclosed system, the charging system begins charging the battery so it reaches a full charge by the time the user is ready to begin using the mobile device.

Additionally, systems and methods are described that provide for interfacing with user calendar type applications or databases on the mobile device to aid in predicting the user's future use patterns. Further, the system and methods are available to interact with an enterprise wide mobile device management system to allow sharing of mobile device use data to optimize the charging of Lithium-Ion batteries across multiple users and mobile devices at multiple locations. The systems and methods allow device characterization by user-defined categories to provide initial configuration before generation of an actual device use profile.

Further, the disclosure describes systems and methods for calculating the rate at which to charge the Lithium-Ion battery to assure that the battery temperature remains below a preconfigured level. Additionally, when the system determines that a discharge is required because of a predicted period of non-use, the system discharges the Lithium-Ion battery at a rate that assures the Lithium-Ion battery temperature remains below a preconfigured level.

To the accomplishment of the foregoing and related ends, certain illustrative aspects are described herein in connection with the following description and the annexed drawings. These aspects are indicative of various ways to practice the invention, all of which are intended to be covered herein. Other advantages and novel features may become apparent from the following detailed description when considered in conjunction with the drawings.

### BRIEF DESCRIPTION OF THE DRAWINGS

FIG. 1 illustrates an embodiment of the target charge level scheduling component interacting with the charging system.

FIG. 2 illustrates an embodiment of the target charge level scheduling component and the associated scheduling characteristics.

FIG. 3 illustrates an embodiment of the optimized Lithium-Ion battery charging system.

FIG. 4 illustrates an embodiment of the optimized Lithium-Ion battery charging system including the charge controller and the discharge controller.

FIG. 5 illustrates an embodiment of the optimized Lithium-Ion battery charging system including the historical use data and the calendar prediction data.

FIG. 6 illustrates an embodiment of the optimized Lithium-Ion battery charging system including the historical use data and the calendar prediction data configuration and archiving.

FIG. 7 illustrates an embodiment of a method of discharging a Lithium-Ion battery based on current battery level and predicted use patterns.

FIG. 8 illustrates an embodiment of a method of charging a Lithium-Ion battery based on current battery level and predicted use patterns.

FIG. 9 illustrates a block diagram of an exemplary, non-limiting operating environment in which various aspects described herein can function.

### DETAILED DESCRIPTION

Various embodiments are now described with reference to the drawings. In the following description, for purposes of explanation, numerous specific details are set forth in order to provide a thorough understanding of one or more embodiments. It may be evident, however, that the various embodiments can be practiced without these specific details. In other instances, well-known structures and devices are shown in block diagram form in order to facilitate describing these embodiments.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers.

The word “exemplary” as used herein means serving as an example, instance, or illustration. Any aspect or design described herein as “exemplary” is not necessarily to be construed as preferred or advantageous over other aspects or designs.

Furthermore, the one or more embodiments can be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that computer communication media includes a carrier wave that can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope of the disclosed embodiments.

Various embodiments will be presented in terms of systems that can include a number of components, modules, and the like. It is to be understood and appreciated that the various systems can include additional components, modules, etc. and/or cannot include all of the components, modules, etc. discussed in connection with the figures. A combination of these approaches may also be used.

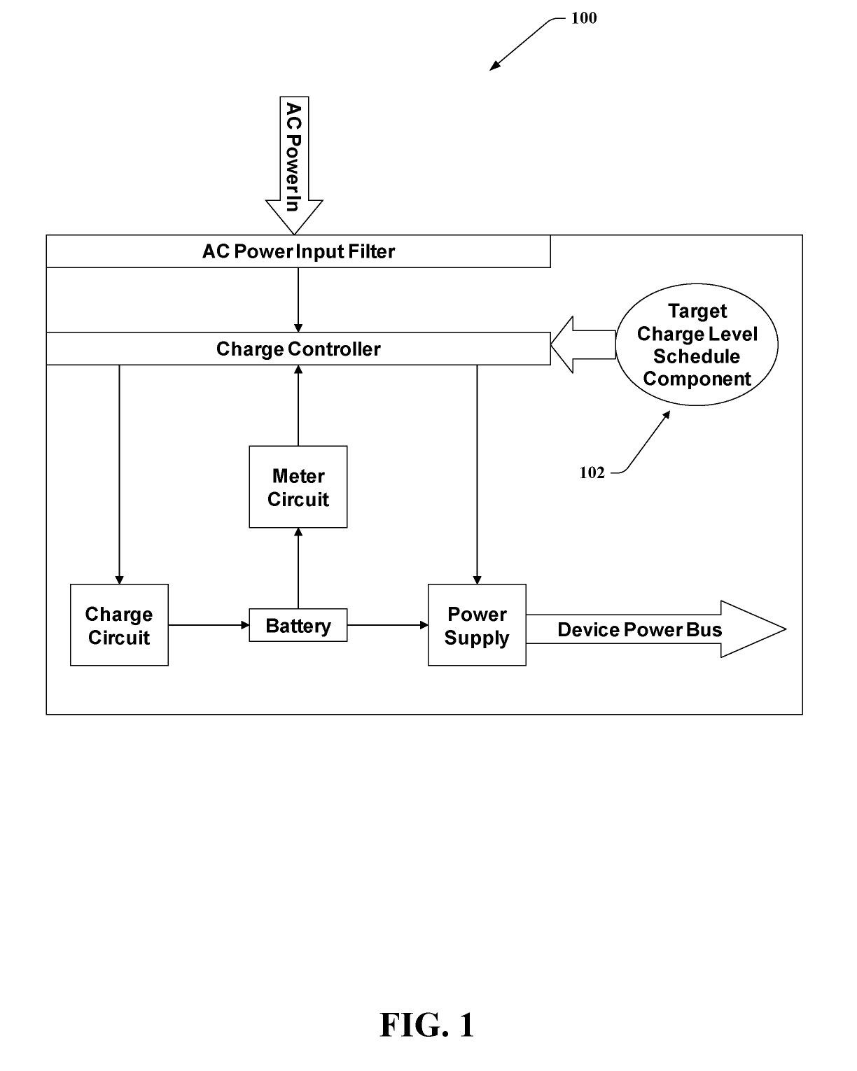

FIG. 1 is an architectural overview of the target level schedule component 102 integrated into an existing battery charging system of a mobile device. The target charge level schedule component 102 combines historical use data and predictions of future use based on information collected from the user's calendar type application, if available, to predict periods of inactivity of the mobile device. Based on the predicted schedule, the target charge level schedule component 102 determines what actions to take in terms of commands to the charge controller.

For example, the target charge level schedule component 102 predicts the period of inactivity for the mobile device. If the target charge level schedule component 102 determines a long period of mobile device inactivity is expected then the target charge level schedule component 102 instructs the charging system 100 charge controller to discharge the Lithium-Ion battery to the desired level of discharge. The target charge level schedule component 102 controls the rate of discharge to prevent a discharge rate that causes a rise in the temperature of the Lithium-Ion battery that would cause chemical damage to the battery. The target charge level schedule component 102 then monitors the trickle charge function of the existing charger to allow the trickle charger to maintain the Lithium-Ion battery at the desired lower charge level.

In another example, the target charge level schedule component 102 determines when battery charging must begin to place the Lithium-Ion battery in a fully charged condition before the user is ready to begin using the mobile device.

When charging the battery, the target charge level component 102 must allow sufficient time to assure that the charge rate is slow enough to prevent the battery from reaching a temperature where chemical damage to the battery will occur.

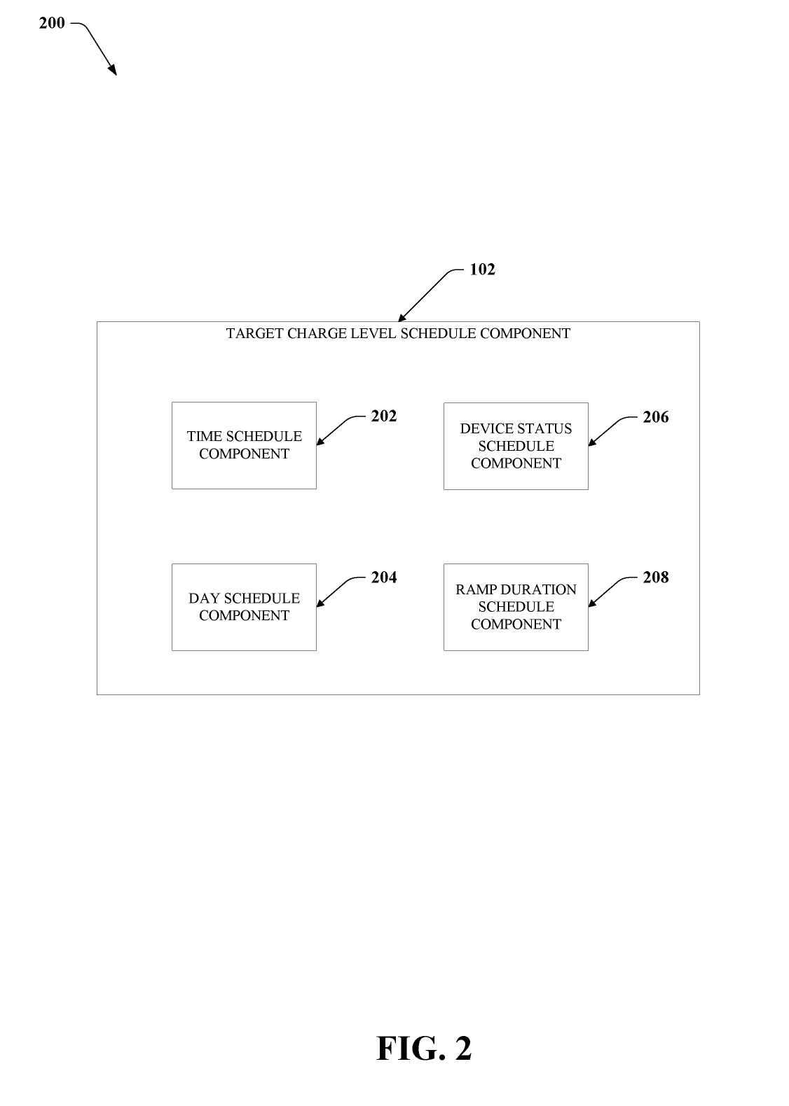

FIG. 2 depicts a target charge level schedule component 102 including the time schedule component 202, the day schedule component 204, the device status schedule component 206 and the ramp duration schedule component 208. The target charge level schedule component 102 provides the ability to enter, edit and archive schedule periods for activities and use of the mobile device. The target charge level schedule component 102 then analyzes the schedule periods to determine charging and discharging strategies for the mobile device lithium-ion battery. Additionally, the target charge level schedule component 102 combines the manually entered schedule data with data from the mobile device calendar application to predict future periods of mobile device activity and inactivity for determining charging and discharging strategies for the mobile device.

Time schedule component 202 provides the ability to enter clock times for start and stop times. For example, an entry in the schedule can reflect the user entered information that a defined period of activity or inactivity begins at 11:00 p.m and ends at 6:00 a.m. It should be noted that the time schedule component 202 permits entry of time specifications in other user definable time formats such as military time. Further, time schedule component 202 provides for entering time data as a start time and a time period commencing at the start time. It should be noted that other time configuration formats are available and are not prohibited by the previous examples.

Day schedule component 204 provides the ability to enter dates, days of the week and months of the year as markers for the beginning or end of a period of device activity or inactivity. In one aspect, the day schedule component 204 can list the days of the week as Monday through Friday or Weekdays. In another aspect, the day schedule component 204 can list the days as a cyclical date such as every Friday. Further, the day schedule component 204 can list dates as absolute dates such as Mar. 30, 2009 as a start date or a stop date.

Device status schedule component 206 provides the ability for the target charge level scheduler 102 to identify what the scheduled time period represents. For example, a particular time period's status can be set to active, meaning the use of the mobile device is required by the user and the mobile device must be charged with sufficient power to accomplish the next use cycle. Alternatively, the status can be set to inactive, meaning use of the mobile device is not required and the target charge level schedule component can schedule the mobile device for optimization in anticipation of the next use cycle.

Ramp duration schedule component 208 provides the ability for the target charge level scheduler 102 to specify the length of time the charging system will take to charge the lithium-ion battery from its current charge level to a fully charged level ready for use in the mobile device. In another aspect of the subject invention, the ramp duration schedule component 208 can calculate the length of time the charging system will take to discharge the lithium-ion battery from its current charge level, above the optimum storage level, to the optimal storage level. The ramp calculation assures that a charging or discharging of the lithium-ion battery does not exceed a predefined temperature of the battery and cause excessive chemical damage to the battery while moving the battery charge level to the desired level as fast as possible.

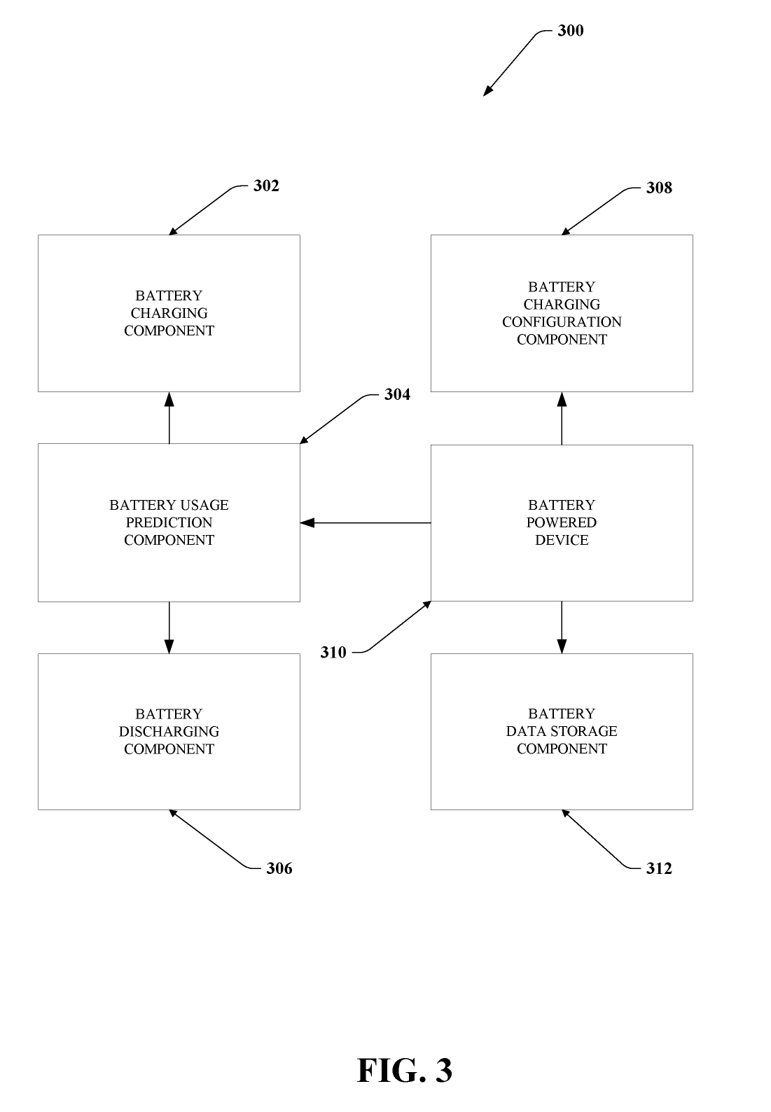

FIG. 3 depicts a lithium-ion battery powered mobile device and its associated battery maintenance system 300 including battery charging component 302, battery usage prediction component 304, battery discharging component 306, battery charging configuration component 308, lithium-ion battery powered device 310 and battery data storage component 312. The battery maintenance systems works in conjunction with the mobile device to optimize the useful life of the lithium-ion battery by maintaining the battery charge at a level optimum for storage while having the battery ready for use when required by the user.

Battery charging component 302 controls the charging of the battery with regard to the level of charge provided to the battery and the rate the charging component 302 provides charge to the battery. For example, if the battery maintenance system 300 decides it is time to charge the battery for the next usage cycle, the battery maintenance system 300 notifies the battery charging component 302 of the level to charge the battery and the rate to provide the charge. The level can be a full charge or it can be a partial charge based on the predicted amount of usage before the user returns the battery to the charging station. In another aspect of the subject innovation, once the battery charging component 302 reaches the required level of charge, the battery charging component will maintain the charge level at this value by “trickle” charging the battery with just enough power to offset the charge loss based on the chemical nature of the battery.

Further, the battery charging component 302 will determine the rate of charge to supply to the battery based on the ultimate charge level requested and the amount of time until the battery must reach this level based on the next usage cycle predicted or known for the user. The basis of this rate of charge or ramp as it is also known is providing sufficient charge rate to the battery to meet the next required usage cycle while assuring that the temperature of the chemical components do not exceed a predefined value, above which where life shortening chemical degradation of the battery occurs.

Battery usage prediction component 304 collects current and archived usage information and combines this with predictions of future battery usage based on the user's calendar application data stored on the mobile device to predict battery charging system behavior. The battery usage prediction component 304 also allows the user to manually enter times and dates when the user knows the mobile device will be either active or inactive. For example, the user might enter a two-week period in July when the user is taking vacation and the mobile device will sit in the charging system unused for this two-week period. In another example, the user might enter the last week of the year when the user will also be on vacation for the holidays. As a result of this manually inputted information from the user, the battery usage prediction component 304 can determine the period of time to hold the battery charge level at the optimum point for storing the battery. At the calculated point in time, the battery charging component 302 must be instructed to be begin charging the battery so the battery reaches the desired level of charge, without exceeding the preconfigured battery temperature, just before the next use cycle begins.

In another aspect of the subject innovation, the battery usage prediction component can interrogate applications, such as a calendar application, on the mobile device to predict the usage patterns of the mobile device by the user. For example, The user's calendar could reflect that the user has a business trip for the first three days of the week in the coming week. The battery usage prediction component 304 is also aware, from the user-supplied configuration, that the user does not use this particular mobile device while away from the office. Therefore, the two-day weekend and the three-day business trip creates a five day window when the mobile device is not required. The battery usage prediction system 304 can then instruct the battery charging component 302 in the optimal charging characteristics to extend the useful life of the battery.

Further, battery usage prediction component 304 is communicatively connected to an enterprise device management system for overall management of a plurality of mobile devices. The enterprise device management system provides additional information related to the usage of similar devices and the availability of similar devices including the device identity and location. For example, a series of inventory mobile devices can be available based on the current use and battery charge state. A user's device can be held at the optimal storage charge condition and the user directed to a like device that was charged for usage but for unavoidable circumstances was not used once reaching its predefined charge state. This rotation of mobile devices provides for extending the useful life of the mobile device battery of multiple devices while also conserving energy by using another mobile device that is charged and ready and holding the user's device in optimal charge storage condition one more day.

In another aspect, the enterprise device management system collects usage information and charge cycle information from the mobile devices and distributes the information to the mobile devices to form a more general background database of the use of the mobile devices. This broad view of mobile device usage allows the battery usage prediction component 304 to more accurately predict usage patterns for the mobile device while also providing and initial usage pattern for a new user without an established history.

Battery discharging component 306 controls the discharging of a battery in the circumstances where it is determined the mobile device is not required for sufficient time and the current charge level is above the optimum storage charge level. The charge level of the battery is reduced to the optimum level allowing storage of the mobile device battery at optimal storage conditions.

In another aspect of the subject innovation, the battery discharging component 306 determines the appropriate rate to discharge the battery to optimal battery storage level conditions. The battery discharge rate is based on preconfigured parameters for the optimum battery charge storage level and the maximum desirable battery temperature. While discharging the battery, the battery discharge component assures that the maximum desirable battery temperature is not exceeded.

Further, battery discharging component 306 can control a heat dissipation device such as a small fan and can use the power being discharged from the battery to run the fan as a cooling system to keep the battery temperature at a minimum. If connected in a collective charger for a bank of mobile devices, the battery discharge component 306 can use the discharged power from one battery as a power feed to the battery charging component 302 of another mobile device battery, therefore saving power and expense for the mobile device owner.

Battery charging configuration component 308 provides the ability to enter and store configuration parameters for the battery maintenance system 300. The configuration parameters include but are not limited to charging rates, discharging rates, maximum battery temperature while charging, maximum battery temperature while discharging, optimal battery storage level and manual schedule data entered by the user. The parameters can be entered by the user, calculated based on usage data or downloaded from enterprise device management system. For example, the user can enter the schedule of non-use periods of the device such as but not limited to weekends and weekdays from 6:00 p.m. to 8:00 a.m. In another example, in an enterprise management based system, the enterprise management system can download optimum battery charge storage levels and maximum battery charging and discharging temperatures.

The battery-powered device 310 is the mobile device containing the battery and the battery maintenance system 300. The battery-powered device 310 is communicatively connected to the battery maintenance system 300 allowing the information transfer between the two systems. For example, the information entered manually by the user is stored on a storage device by the battery-powered device and communicated to the battery maintenance components for further action. In one example, the optimal battery charge level is downloaded to the battery-powered device from the enterprise device management system and then communicated to the battery-charging component for assuring the proper battery storage charge level.

Battery data storage component 312 provides the storage capability for data associated with the battery maintenance system 300. Associated data includes but is not limited to configuration parameters entered by the user, usage data generated by the battery usage prediction component 304, battery charge and discharge data generated by the battery charge component 302 and the battery discharge component 306 and enterprise configuration and usage data downloaded to the mobile device from the enterprise device management system.

Battery data storage component 312 can be any suitable data storage device (e.g., random access memory, read only memory, hard disk, flash memory, optical memory), relational database, XML, media, system, or combination thereof. The battery data storage component 312 can store information, programs, historical process data and the like in connection with the optimized battery charging system and the use data described herein. For example, the use patterns developed by the user over an extended period of time are archived in addition to the configuration provided by the user for the calendar integration and the use data collection strategies.

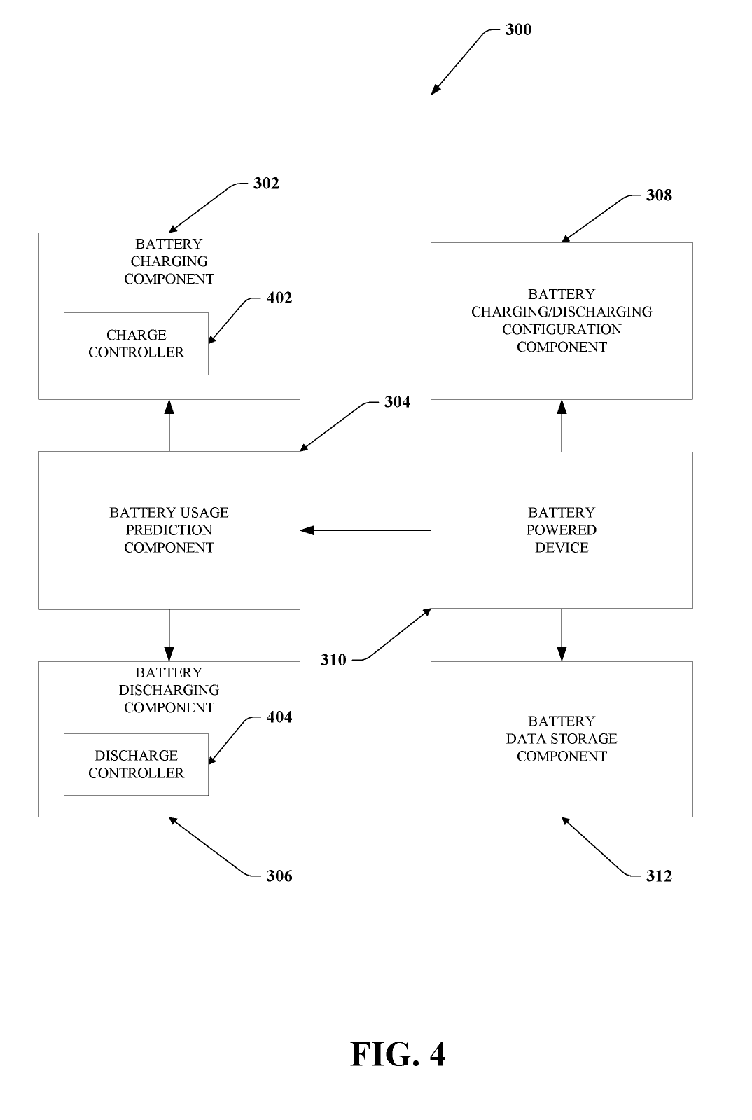

FIG. 4 once again depicts a lithium-ion battery powered mobile device 310 and its associated charge controller 402 and discharge controller 404. The charge controller 402 and the discharge controller 404 assure that the batter is stored in an optimal charge condition when not required and ready with sufficient power to provide operation of the mobile device until the next predicted charge cycle.

Charge controller component 402 is communicatively connected to the battery usage prediction component 304 and the battery charging configuration component 308. The charge controller component 402 obtains configuration information from the battery charging configuration component 308 related to the optimal charge level for the battery and the maximum desirable charge rate for the battery. The optimum charge storage level for a battery is based on the battery chemistry and can differ from one battery type to the next. For example, a Lithium-ion battery can have an optimum charge storage level of 45% of full charge while another battery type can have an optimum storage level that can be 80% of full charge.

In another aspect of the subject innovation, the charge controller component 402 obtains configuration information from the battery charging configuration component 308 related to the maximum desirable rate of charging the battery. The battery useable life can be extended by assuring that the battery temperature remains below a predetermined value. The maximum desirable temperature and the rate of temperature rise differs between different battery types, with respect to battery chemistry, therefore the user can select the battery type and tune the charge rate based on environmental conditions surrounding the battery. For example, you can charge a battery at a faster rate in the winter in a northern area faster than you can charge the same battery in the summer in a southern area.

Combining this collected information, the charge controller component 402 calculates the rate at which it can provide power to the battery to reach the desired charge level without exceeding the specified battery temperature. After reaching the desired charge level, the charge controller component 402 invokes a “trickle” charge capability to offset any losses incurred by the battery while waiting for the next use cycle.

Further, the charge controller 402 collects information from the battery usage prediction component 304 regarding the date and time of the next usage cycle and the level of charge required by the specified date and time. The charge controller 402 then calculates the rate at which it should provide charging power to the battery to meet the next scheduled usage cycle without exceeding a charge rate that would raise the battery temperature to a level causing chemical damage to the battery. The battery usage prediction component 304 can update the charge controller component 402 with new data and the charge controller component 402 will recalculate the charging strategy and adjust the charge rate based on the updated calculations.

Discharge controller component 404, similar to the charge controller component 402, is communicatively connected to the battery usage prediction component 304 and the battery charging configuration component 308. The discharge controller component 404 obtains configuration information from the battery discharging configuration component 308 related to the optimum battery storage level and the required rate of discharging the battery that assures the battery temperature does not exceed a level that will cause chemical damage to the battery and shorten the useful life of the battery.

Additionally, in a similar fashion to the charge controller component 402 described above, the discharge controller component collects data from the battery usage prediction component 304 relating to predictions and schedules concerning the date and time for the next usage cycle. Further, the discharge controller 404 allows the configuration of using the discharged power to operate cooling devices to control the battery temperature while discharging the battery to the required storage level. For example, the discharge controller 404 can use the discharged power activate a fan or exhaust vent system to maintain a cool air flow across the battery surface while the discharge controller 404 is discharging the battery.

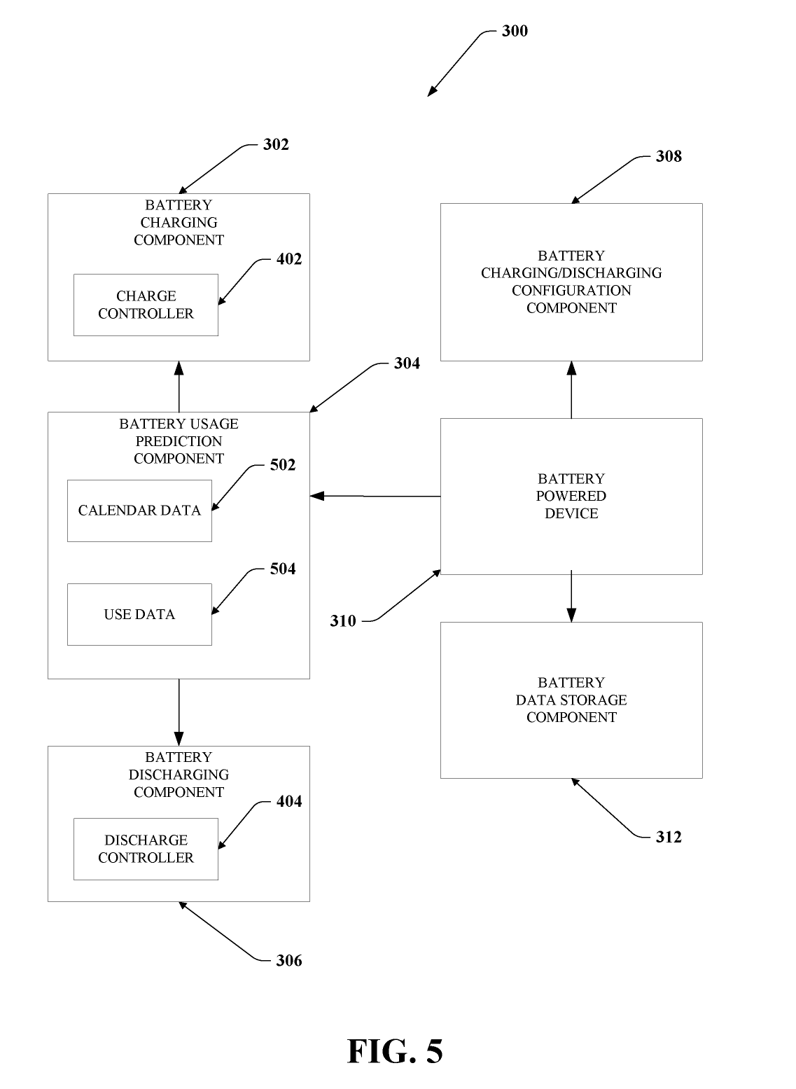

Referring now to FIG. 5, the calendar data component 502 and the use data component 504 of the battery usage prediction component are illustrated. The calendar data component is communicatively connected to the user's calendar application on the mobile device. The calendar data component 502 interrogates the user's calendar application to identify times and events when the user will either require or not require the use of the mobile device. For example, the user can have a schedule vacation that results in non-use of the device for a two-week period. In another example, the user can have a scheduled business trip where the device is required every day. It should be noted that other application types can provide schedule information and other event types can provide information representing times when the mobile device is either needed for a use cycle or not needed and available for a storage cycle.

From the collected information, the calendar data component 502 can generate a schedule of times when the battery can be discharged to the optimum storage charge level or charged to the optimum storage charge level in anticipation of an extended period of storage before the next usage cycle. Although the length of this period may vary, the calendar data component performs similar tasks. First, the calendar data component 502 determines the length of time from the present to the next predicted use of the device. Next, the calendar data component determines if sufficient time is available before the next charge cycle must begin. The calendar data component bases sufficient time on the configured charge rate and the charge level required for the next usage cycle. The calendar data component is configurable with respect to how aggressively it calculates battery storage cycles based on information obtained from the calendar.

The use data component 504 searches data reflecting the user's past behavior with this specific mobile device and with other similar devices. Based on the user's past patterns, the use data component generates a prediction of the user's future behavior with the device. The use data component 504 merges and resolves with the prediction created by the calendar data component 502 and uses the generated prediction to create the charging schedule for the mobile device.

In another aspect of the subject innovation, the use data component 504 is communicatively connected to a database of the user's historical usage of the mobile device. The use data component 504 can analyze the historical usage data and detect patterns of use indicating upcoming times when the mobile device is not required or when the amount of use by the user does not require a full charge between charge cycles. For the case of a non-use cycle, the use data component 504, through the battery usage prediction component 304, can advise the battery discharging component 306 discharge controller 404 to prepare the battery for a storage cycle. For the case of the usage between charge cycles not requiring a full charge, the use data component 504 can advise the charge controller 402 to charge to a lower level because a full charge is not necessary. In calculating the charge level, the charge controller can charge the battery to a level that approximately returns the battery to optimum storage charge level as the user completes the next usage cycle.

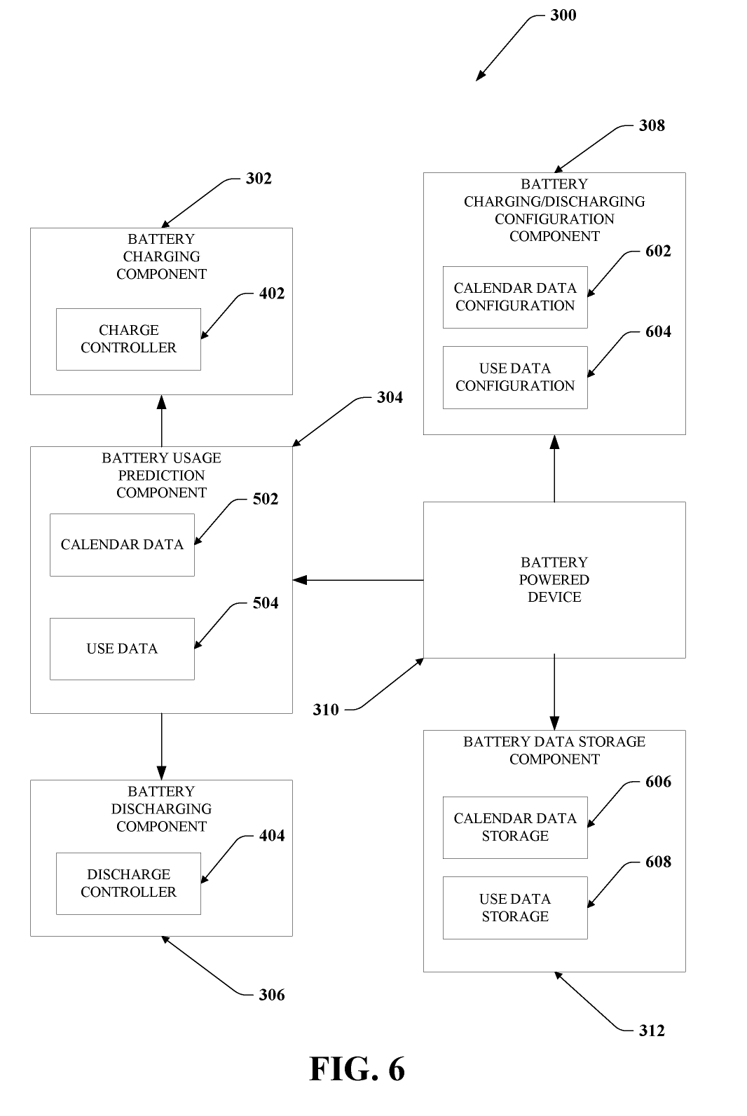

Referring next to FIG. 6, the battery charging/discharging configuration component 308 includes the calendar data configuration component 602 and the use data configuration component 604 and the battery data storage component 312 includes the calendar data storage component 606 and the use data storage component 608.

The calendar data configuration component 602 provides the user an interface to configure interaction between the battery usage prediction component 304 and the user's calendar or calendar-like application. For example, the user can enter the application name for the case where the optimized battery charging system is aware of the application interface. In another aspect, the user can specify a data file format allowing the optimized battery charging system to interrogate the calendar application data file. Further, if the calendar has an interface for requesting calendar data items, the calendar data configuration component 602 provides the ability to configure the battery usage prediction component 304 to interact with the calendar application through the interface.

In another aspect, the calendar data configuration component 602 allows the user to specify a confidence factor to use in weighting the data collected from the calendar application in predicting the user's periods of use and non-use of the mobile device. For example, the user can configure the optimized battery charging system to ignore scheduled events that the user did not acknowledge as attended. Further, the user, using the calendar data configuration 602 interface, can provide buffer time zones before and after calendar events to allow a safety margin for charging or to defer discharging in case of an expected period of non-use.

The use data configuration component 604 provides the user the ability to specify the criteria the optimized battery charging system should use in collecting and retaining data generated by the use of the mobile device. For example, the user can configure a maximum age of retained data so the optimized battery charging system removes older data to make way for newer data. In another aspect, the user can configure when and if the mobile device should upload the data to an enterprise device management system for further analysis and distribution to other mobile devices. Further, the user can configure if the mobile optimized battery charging system should download use data from other like mobile devices to coordinate charging and storage cycles among like mobile devices.

The calendar data storage component 606 provides the ability to persist information accumulated from interrogating the user's calendar application. For example, if the battery usage prediction component 304 analyzes the user's calendar and creates a prediction model of future user activities, the battery usage prediction component 304 can save the prediction model on the calendar data storage component 606 for use at a future time. In another aspect, the calendar data storage component 606 can store information regarding the interaction mechanism with the user's calendar application so the battery usage prediction component can interrogate the user's calendar whenever necessary without requiring configuration information by the user at each interrogation.

The use data storage component 608 provides the user the ability to store a historical record of the use characteristics developed by the user. In one aspect, the user can configure how often data is collected and how long collected data is kept. In another aspect, the user can configure whether use data is uploaded to an enterprise device management system for further analysis and sharing with similar mobile devices.

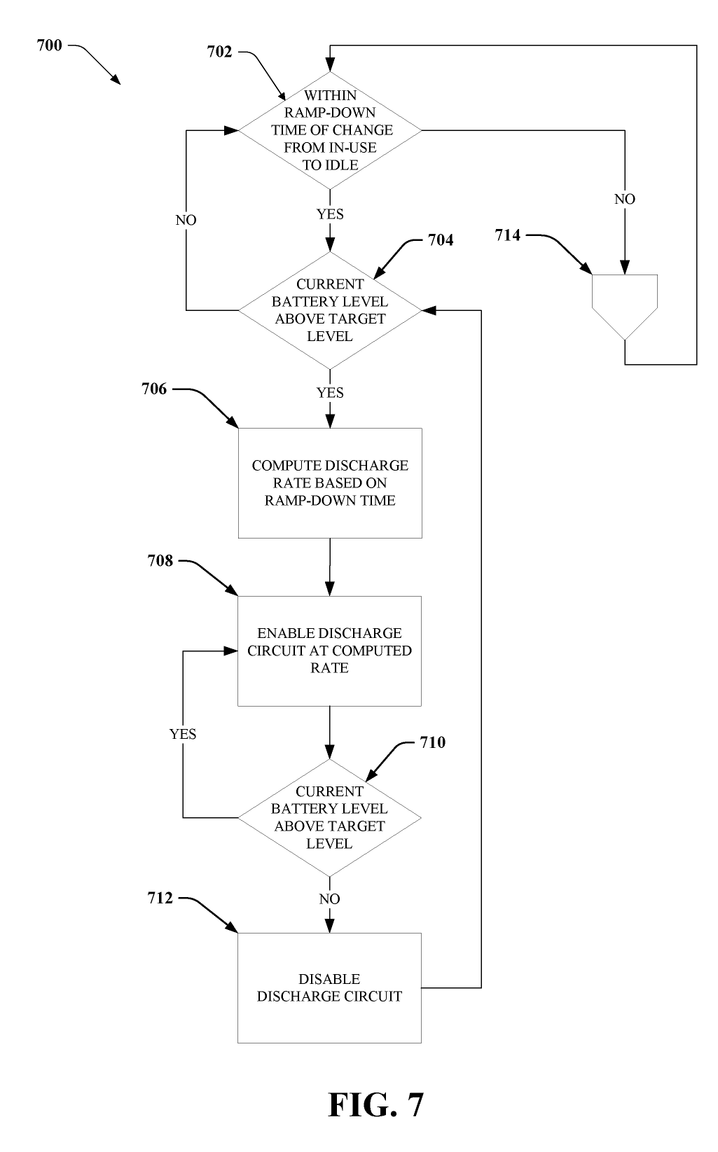

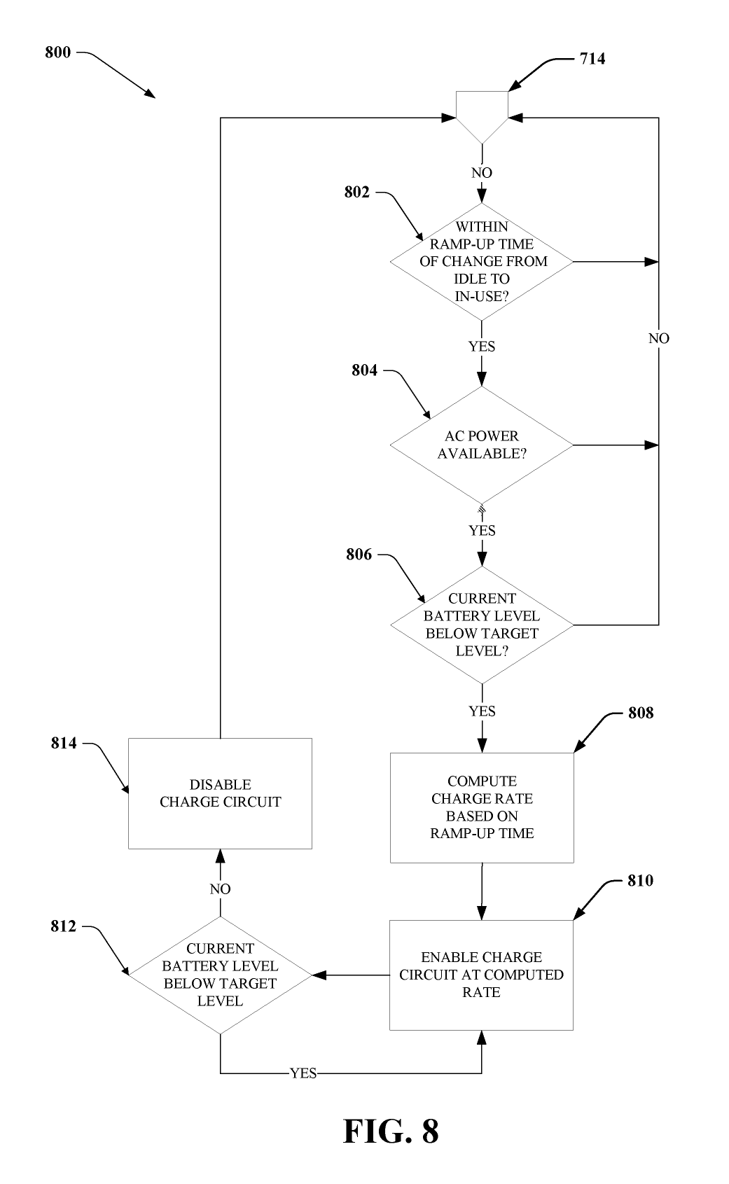

Referring now to FIG. 7 and FIG. 8, illustrated is a method of extending the useful life of a lithium-ion battery. Beginning at step 702, a determination is made of whether the mobile device is within the ramp-down time for a change of the mobile device from in-use to idle. If the mobile device is within the ramp-down time then the method proceeds to step 704. At step 704, the method makes another determination whether the current battery level is above the preconfigured target level for storage. If the current battery level is not above the preconfigured target level then the method returns to step 702 and begins again. If the current battery level is above the preconfigured target level then the method proceeds to step 706.

At step 706 the method now computes the discharge rate based on the ramp-down time. The method calculates the discharge rate to reach the optimum charge storage level without exceeding the temperature maximum preconfigured for the battery. After the method calculates the discharge rate, the method proceeds to step 708. At step 708, the method sets the discharge rate and enables the discharge circuit. It should be noted that the user could configure the discharged power to operate cooling devices allowing a faster discharge without exceeding the preconfigured maximum temperature of the battery. Next, the method proceeds to step 710.

At step 710 the method determines if the current battery level is still above the target level for optimum storage conditions. If the battery level is still above the target level then the method continues discharging the battery. If the battery level has reached the target charge level then the method proceeds to step 712. At step 712 the method disables the discharge circuit and begins waiting for the next battery charge or discharge event.

In another aspect of the method, depicted in FIG. 8 at step 802, the method determines if the mobile device is within the ramp-up time for a change of the mobile device from idle to in-use. If the method determines the mobile device is within the ramp-up time then the method proceeds to step 804. At step 804, the method determines if AC power is available to conduct a mobile device charge cycle. If the method determines AC power is available then the method proceeds to step 806. At step 806, the method determines if the current battery charge level is below the target charge level. If the current battery charge level is below the target charge level then the method proceeds to step 808.

At step 808, the method computes the charge rate based on the ramp-up time. The method will charge the battery at a rate that places the battery at the required level of charge by the end of the ramp-up time. The method also assures that the rate of charge does not cause the battery to exceed the maximum predefined temperature. After computing the charge rate, the method proceeds to step 810. At step 810 the method sets the calculated charge rate and enables the charge circuit. After enabling the charge circuit the method proceeds to step 812.

At step 812, the method determines if the current battery level is below the target charge level. If the current battery charge level is below the target battery charge level then the method continues charging the battery and checking if the battery charge level has reached the target charge level. Once the method determines at step 812 that the current battery charge level has reached the target battery charge level, the method proceeds to step 814. At step 814, the method disables the battery charge circuit and the battery charge cycle is completed.

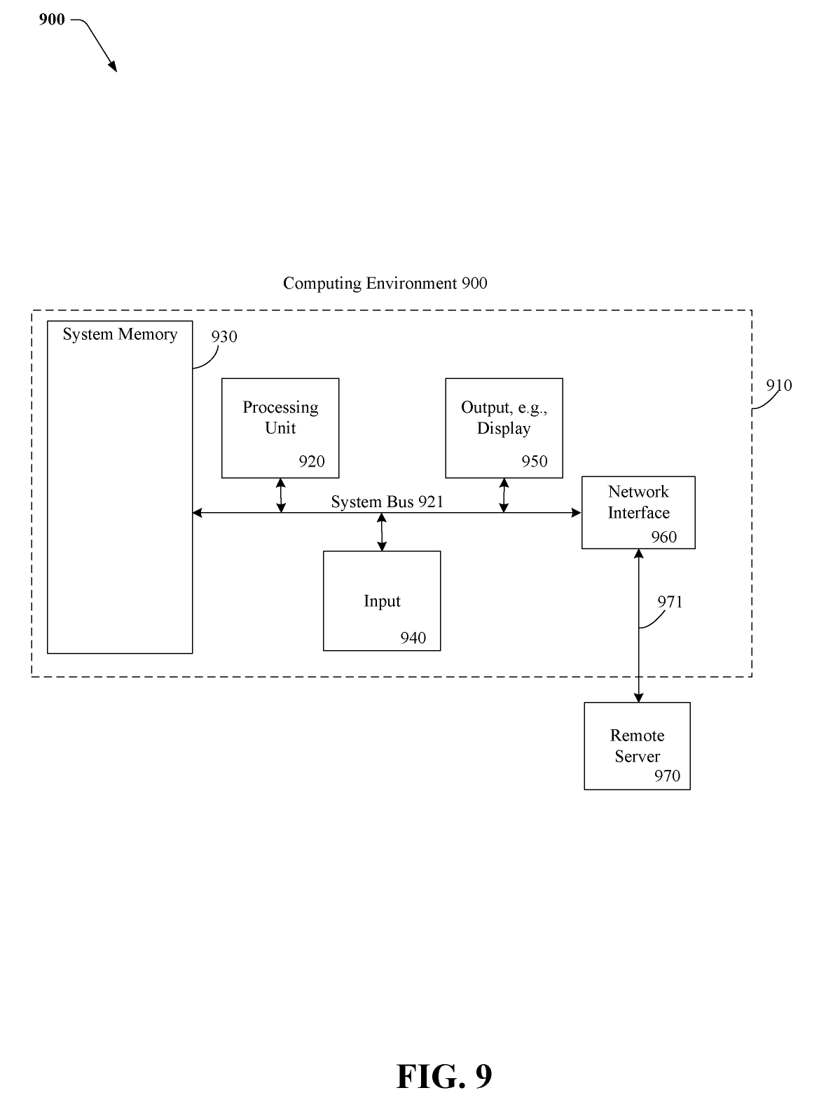

FIG. 9 illustrates an example of a suitable computing system environment 900 implementing the claimed subject matter. Although as made clear above, the computing system environment 900 is only one example of a suitable computing environment for a mobile device and is not intended to suggest any limitation as to the scope of use or functionality of the claimed subject matter. Further, the computing environment 900 is not intended to suggest any dependency or requirement relating to the claimed subject matter and any one or combination of components illustrated in the example operating environment 900.

With reference to FIG. 9, an example of a remote device for implementing various aspects described herein includes a general purpose computing device in the form of a computer 910. Components of computer 910 can include, but are not limited to, a processing unit 920, a system memory 930, and a system bus 921 that couples various system components including the system memory to the processing unit 920. The system bus 921 can be any of several types of bus structures including a memory bus or memory controller, a peripheral bus, and a local bus using any of a variety of bus architectures.

Computer 910 can include a variety of computer readable media. Computer readable media can be any available media accessible by computer 910. By way of example, and not limitation, computer readable media can comprise computer storage media. Computer storage media includes volatile and nonvolatile as well as removable and non-removable media implemented in any method or technology for storage of information such as computer readable instructions, data structures, program modules or other data.

Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 910.

Communication media can embody computer readable instructions, data structures, program modules or other data in a modulated data signal such as a carrier wave or other transport mechanism and can include any suitable information delivery media.

The system memory 930 can include computer storage media in the form of volatile and/or nonvolatile memory such as read only memory (ROM) and/or random access memory (RAM). A basic input/output system (BIOS), containing the basic routines that help to transfer information between elements within computer 910, such as during start-up, can be stored in memory 930. Memory 930 can also contain data and/or program modules that are immediately accessible to and/or presently being operated on by processing unit 920. By way of non-limiting example, memory 930 can also include an operating system, application programs, other program modules, and program data.

The computer 910 can also include other removable/non-removable, volatile/nonvolatile computer storage media. For example, computer 910 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 921 through a non-removable memory interface such as an interface, and a magnetic disk drive or optical disk drive can be connected to the system bus 921 by a removable memory interface, such as an interface.

A user can enter commands and information into the computer 910 through input devices such as a keyboard or a pointing device such as a mouse, trackball, touch pad, and/or other pointing device. Other input devices can include a microphone, joystick, game pad, satellite dish, scanner, or the like. These and/or other input devices can be connected to the processing unit 920 through user input 1040 and associated interface(s) that are coupled to the system bus 921, but can be connected by other interface and bus structures, such as a parallel port, game port or a universal serial bus (USB). A graphics subsystem can also be connected to the system bus 921. In addition, a monitor or other type of display device can be connected to the system bus 921 via an interface, such as output interface 950, which can in turn communicate with video memory. In addition to a monitor, computers can also include other peripheral output devices, such as speakers and/or a printer, which can also be connected through output interface 950.

The computer 910 can operate in a networked or distributed environment using logical connections to one or more other remote computers, such as remote server 970, which can in turn have media capabilities different from device 910. The remote server 970 can be a personal computer, a server, a router, a network PC, a peer device or other common network node, and/or any other remote media consumption or transmission device, and can include any or all of the elements described above relative to the computer 910. The logical connections depicted in FIG. 10 include a network 971, such local area network (LAN) or a wide area network (WAN), but can also include other networks/buses. Such networking environments are commonplace in homes, offices, enterprise-wide computer networks, intranets and the Internet.

When used in a LAN networking environment, the computer 910 connects to the LAN 1071 through a network interface or adapter. When used in a WAN networking environment, the computer 910 can include a communications component, such as a modem, or other means for establishing communications over the WAN, such as the Internet. A communications component, such as a modem, which can be internal or external, connects to the system bus 921 via the user input interface at input 940 and/or other appropriate mechanism. In a networked environment, program modules depicted relative to the computer 910, or portions thereof, can be stored in a remote memory storage device. It should be appreciated that the network connections shown and described are exemplary and other means of establishing a communications link between the computers can be used.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and that any one or more middle layers, such as a management layer, can be provided to communicatively couple to such sub-components in order to provide integrated functionality. Any components described herein may also interact with one or more other components not specifically described herein but generally known by those of skill in the art.

In view of the exemplary systems described supra, methodologies that can be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, can be implemented which achieve the same or a similar result. Moreover, not all illustrated blocks are required to implement the methodologies described hereinafter. In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, no single embodiment shall be considered limiting, but rather the various embodiments and their equivalents should be construed consistently with the breadth, spirit and scope in accordance with the appended claims.

What is claimed is:

1. A battery charging system for extending the useful life of a battery, the system comprising:
a battery usage prediction component for predicting future use of a device containing the battery;
a battery charge level schedule component for determining when to begin and end a charge or discharge cycle; and
a battery charging component for charging the battery to the configured charge level in preparation for a usage cycle.

2. The system of claim 1, the battery charging system is embedded in a mobile device.

3. The system of claim 2, further comprising:
a battery charging configuration component for entering configuration data for optimizing battery charge and discharge levels;
a battery discharging component for discharging the battery to the configured charge level in preparation for a storage cycle; and
a battery data storage component for persisting battery charge optimization and configuration data.

4. The system of claim 3, the battery charging configuration component facilitates entering information identifying a user's calendar application on the mobile device.

5. The system of claim 3, the battery charging configuration component facilitates entering information specifying the optimum charge level for storing the battery.

6. The system of claim 3, the battery charging configuration component facilitates entering information specifying the maximum rate for charging the battery.

7. The system of claim 3, the battery charging configuration component facilitates entering information specifying the maximum rate for discharging the battery.

8. The system of claim 3, the battery charging configuration component facilitates entering information specifying the maximum battery temperature allowable while charging the battery.

9. The system of claim 3, the battery charging configuration component facilitates entering information specifying the maximum battery temperature allowable while discharging the battery.

10. The system of claim 4, the battery usage prediction component facilitates predicting future usage based on the user's future calendar schedule.

11. The system of claim 2, the battery usage prediction component facilitates predicting future usage based on the user's historical mobile device use data.

12. The system of claim 2, the battery usage prediction component facilitates predicting future usage based on data downloaded from an enterprise device management system.

13. The system of claim 1, the battery is a Lithium-Ion battery.

14. A method, stored in a memory and executing on a processor in a device, for extending the useful life of a rechargeable battery installed in the device, the method comprising:
configuring the battery maximum allowable temperature, ramp-up time and ramp-down time;
determining a schedule for charging and discharging the battery based on historical and predicted future use of the battery;
determining when a ramp-up or ramp-down period has been entered;
calculating charge and discharge rates based on the ramp-up and ramp-down periods respectively;
enabling a charge or discharge circuit, at the calculated charge or discharge rate;
determining when the battery charge level meets the configured charge or discharge level; and
disabling the charge or discharge circuit.

15. The method of claim 14, the battery is a Lithium-Ion battery.

16. The method of claim 14, the schedule for charging and discharging the battery is communicated by the device to an enterprise device management system for distribution to other devices.

17. The method of claim 14, the charge schedule disables the charge circuit before the battery receives a full charge because predicted usage requires less than a full charge before the next charge cycle.

18. The method of claim 14, a trickle charge maintains the battery at an optimum storage charge level until the ramp-up period begins.

19. The method of claim 14, the discharge circuit directs discharge power to a battery cooling apparatus.

20. The method of claim 14, the discharge circuit directs discharge power to a plurality of batteries in the ramp-up period.

21. A battery charging system for extending the useful life of a battery, the system comprising:
means for predicting future use of a device containing the battery;
means for determining when to begin and end a charge or discharge cycle; and
means for charging the battery to the configured charge level in preparation for a usage cycle.

22. The system of claim 21, further comprising:
means for entering configuration data for optimizing battery charge and discharge levels;
means for discharging the battery to the configured charge level in preparation for a storage cycle; and
means for persisting battery charge optimization and configuration data.
